(19) United States
(12) Patent Application Publication
(10) Pub. No.: US 2014/0078758 A1
(43) Pub. Date: Mar. 20, 2014

(54) LED LIGHT ASSEMBLIES AND METHODS OF MAKING SUCH ASSEMBLIES

(71) Applicant: MAXGREEN LED LIMITED, Road Town (VG)

(72) Inventors: Ivan Foti, Richmond (GB); Antony Arman, Surat Thani (TH)

(73) Assignee: MAXGREEN LED LIMITED, Road Town (VG)

(21) Appl. No.: 14/116,516

(22) PCT Filed: May 8, 2012
(86) PCT No.: PCT/EP2012/058424

§ 371 Date: Nov. 8, 2013

(30) Foreign Application Priority Data
May 11, 2011 (GB) 1107822.7

(51) Int. Cl. F21V 21/14; F21V 23/00; F21K 99/00; F21V 29/00

(52) U.S. Cl. CPC F21V 21/14; F21V 29/22; F21V 29/2206; F21V 23/008; F21K 9/90
USPC 362/418; 362/382; 29/825

(57) ABSTRACT

An LED light assembly comprises an aluminium extrusion cut to length to form a heat sink (20) with a hollow interior that may be semi-circular in cross-section or any other convenient cross-section to allow air flow through the heat sink and including a mounting surface (21) for supporting and conveying heat from an LED light source (62) mounted on the surface. The extrusion has a heat dissipating surface (24) with fins (27) for receiving and dissipating heat from the LED light sources (62) on the mounting surface (21). The fins (27) support items such as anchors (45), brackets (37) and casings (28, 35) also formed by lengths of respective extrusions and a sliding fit on the heat sink (20).

The invention relates to LED light assemblies and to methods of making such assemblies.

When designing an LED light assembly, one of the most important considerations is the dissipation of the heat generated by the LED light source carried by the assembly. A large proportion of the heat generated by the source passes to the assembly where it is dissipated. The LED light source must not exceed a certain temperature and so the assembly must dissipate sufficient heat to keep the source below that temperature. If an LED light source exceeds a maximum rated operating temperature, the lifetime and performance will be reduced. The reduction in lifetime and performance is directly proportional to the excess of temperature and the duration for which the source is exposed to the excess temperature.

In order to dissipate the heat, the assembly requires a certain surface area depending on the wattage of the LED light source used. For example, a 100 watt LED light source might require at least 10,000 cm² of surface area. A 50 watt LED light source might require 6,000 cm² etc.

With existing LED light assemblies, the assembly is formed from cast or machined parts and a separate assembly, and thus separate tooling, is required for each type and wattage of LED light source. For example, a 100 watt street LED light source will require a different assembly to a 100 watt LED flood light source. Similarly a 50 watt street LED light source will require yet another assembly.

Of course, it would be possible to use the same assembly for a 50 watt LED light source as for a 100 watt LED light source but not visa versa. This is not, however, practical since the cost of a 100 watt assembly is substantially more expensive than a 50 watt assembly due to the excess of material and the whole light assembly would not be competitive in price. In addition, it would also be very heavy compared to a dedicated 50 watt assembly.

According to a first aspect of the invention, there is provided an LED lighting assembly comprising a portion of metal extrusion fowling a heat sink with a hollow interior and including a mounting surface for supporting and conveying heat from an LED light source mounted on the surface, a heat dissipating surface for receiving and dissipating heat from the mounting surface and a support.

By forming the assembly as a portion of an extrusion, an assembly of any desired length (and thus any desired heat dissipation capacity) can be produced from the same extruded member.

According to a second aspect of the invention, there is provided a method of forming an LED light assembly comprising forming a hollow metal extrusion including a mounting surface, a heat dissipating surface and a support, cutting a length of said extrusion and mounting an LED light source on the mounting surface of said portion of the extrusion.

The following is a more detailed description of some embodiments of the invention, by way of example, reference being made to the accompanying drawings, in which:

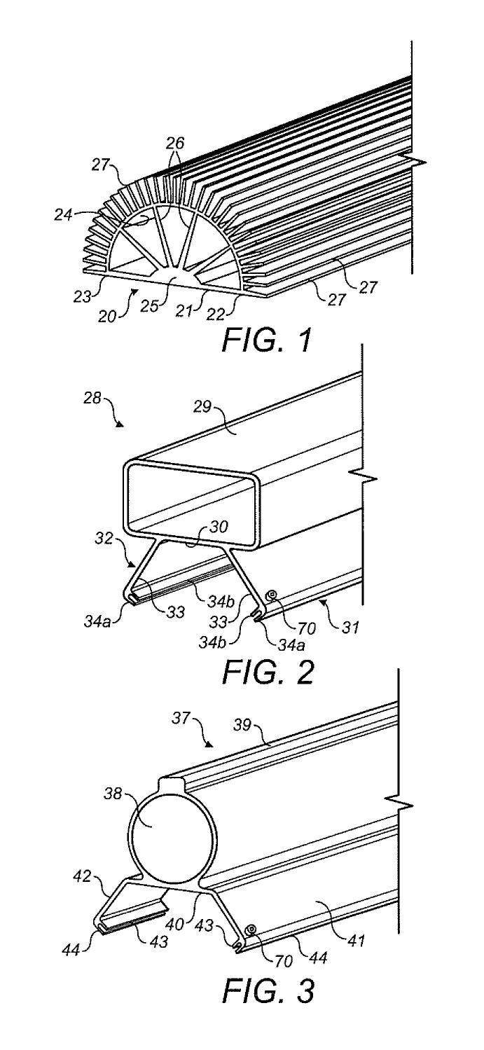

FIG. 1 is a perspective view of a heat sink for an LED light assembly and formed by an extrusion;

FIG. 2 is a perspective view of a casing formed by an extrusion and for use with the heat sink of FIG. 1;

FIG. 3 is a perspective view of a bracket formed by an extrusion and for use with the heat sink of FIG. 1;

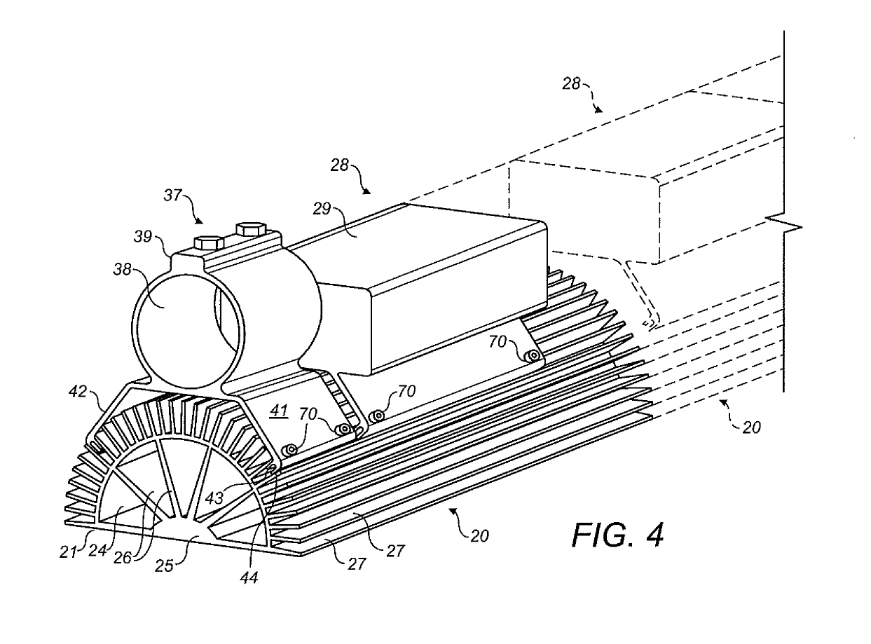

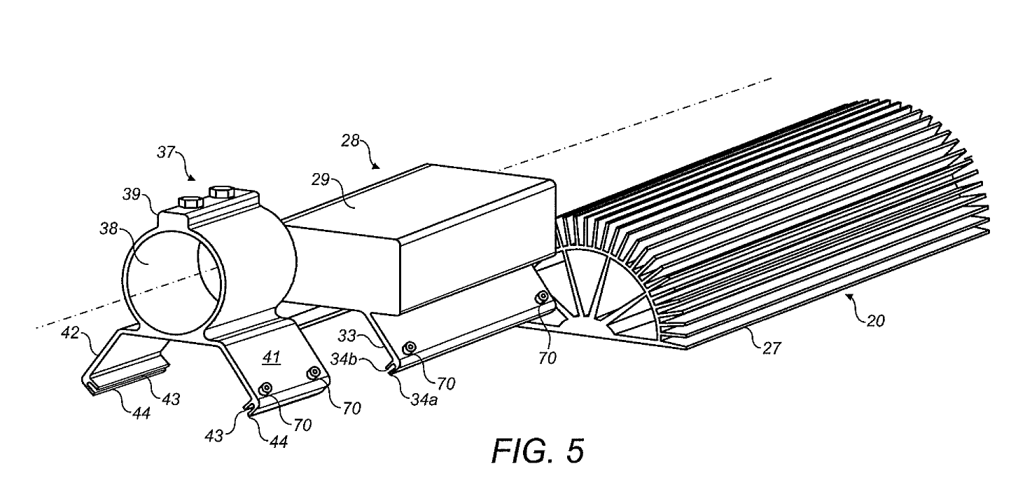

FIG. 4 is a perspective view of a first LED light assembly including two LED light sources and formed by a heat sink of FIG. 1, a casing of FIG. 2 and a bracket of FIG. 3;

FIG. 5 is an exploded view of the LED light assembly of FIG. 4;

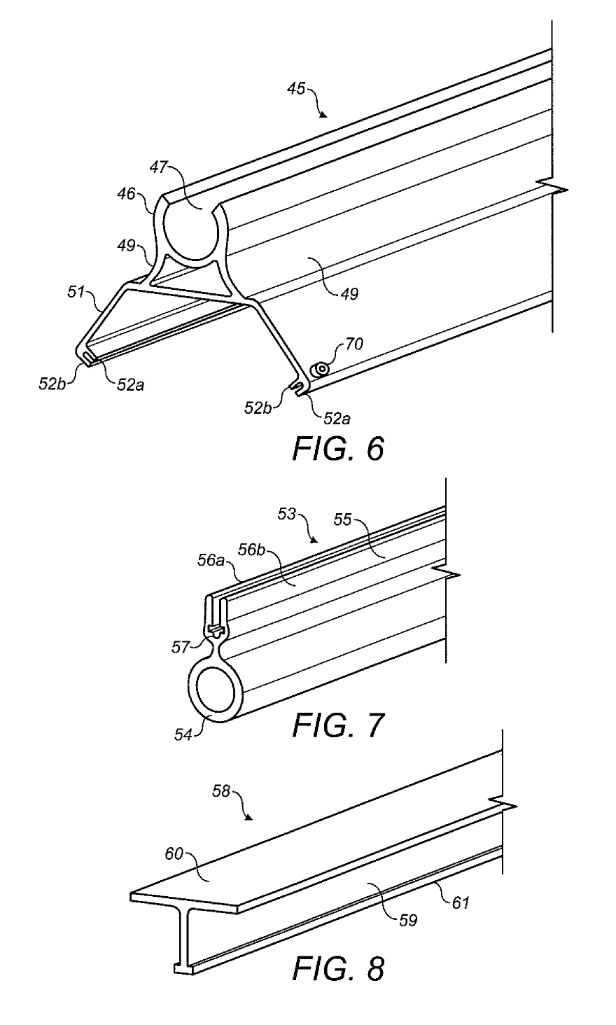

FIG. 6 is a perspective view of an anchor formed by an extrusion and for use with the heat sink of FIG. 1;

FIG. 7 is a perspective view of a link member formed by an extrusion and for use with the anchor of FIG. 6;

FIG. 8 is a perspective view of a mounting formed by an extrusion and for use with the link of FIG. 7;

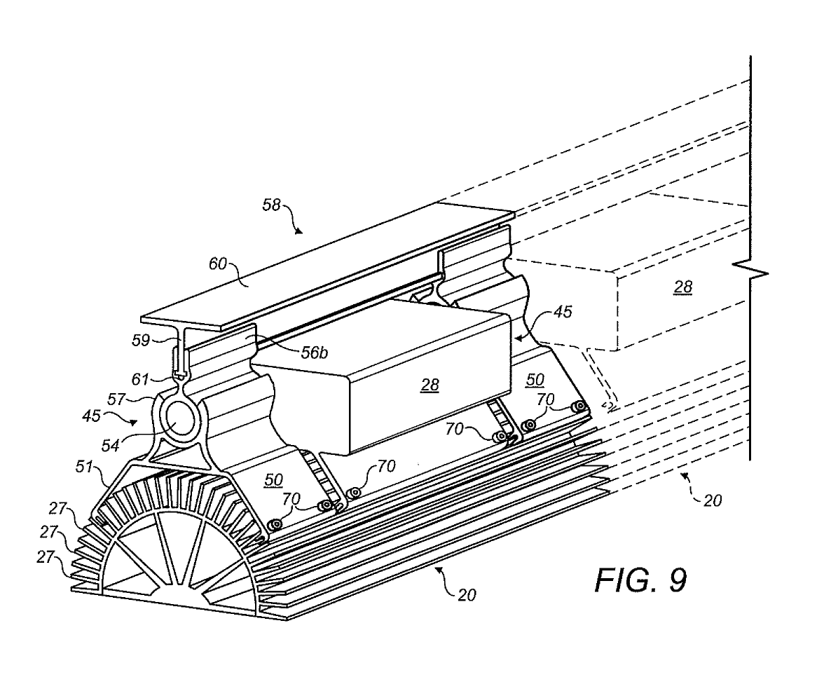

FIG. 9 is a perspective view of a second LED light assembly including two LED light sources and formed by a heat sink of FIG. 1, a casing of FIG. 2, two anchors of FIG. 6, two links of FIG. 7 and a mounting of FIG. 8;

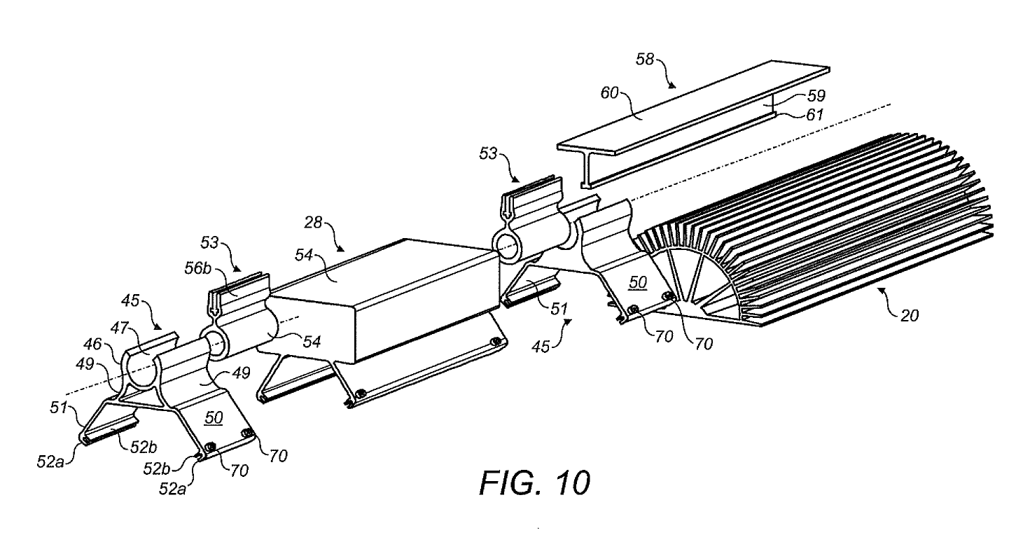

FIG. 10 is an exploded view of the LED light assembly of FIG. 9, and

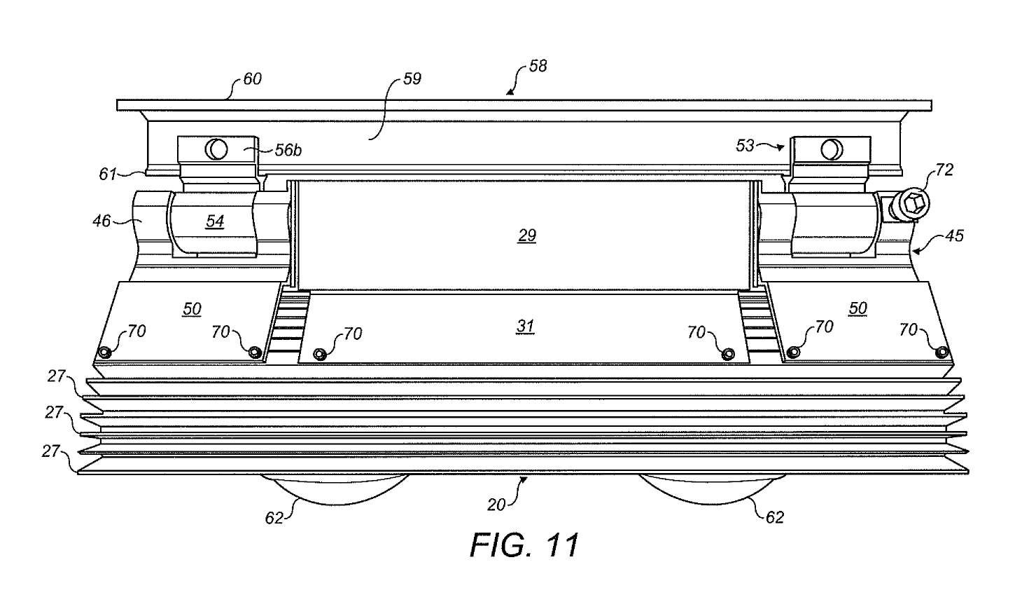

FIG. 11 is a side elevation of the LED light assembly of FIGS. 9 and 10.

The first LED light assembly shown in FIGS. 4 and 5 is formed from two modular extruded members. These are shown in FIGS. 1 and 2 and will now be described in detail. The members of these Figures are formed by extrusion, using conventional extruding techniques, and are made of a heat conducting metal such as, for example, aluminium.

The first extrusion is a heat sink 20 shown in FIG. 1 and comprising a flat mounting surface 21 in form of a wall having spaced first and second side edges 22, 23 respectively. These side edges 22, 23 are parallel and extend parallel to the axis of the extrusion. A semi-circular section heat dissipating surface 24 extends between the first and second side edges 22, 23 and defines, with the mounting surface 21 a hollow interior to the extrusion.

The interior side of the mounting surface carries a boss 25 that extends along the length of the mounting surface intermediate the first and second side edges 22, 23. Four angularly spaced longitudinally extending dividing surfaces 26 extend from the boss 25 to the inner side of the heat dissipating surface 24 in respective generally radial directions.

The outer side of the heat dissipating surface 24 is provided with a plurality of longitudinally extending angularly spaced heat dissipating fins 27. As shown, there are about 30 fins spaced by about 6° but there may be more or less fins 27 as required.

The width of the mounting surface 21, (and consequently the diameter of the heat dissipating surface 24) may be 160 mm. The extrusion can be produced in any convenient length and this may be two or more meters.

Referring to FIG. 2, the second extrusion is a casing 28 including a rectangular cross-section body 29 having an under surface 30 and a pair of mounting arms 31, 32 projecting at an angle from the under surface 30. Each mounting arm 31, 32 includes a planar portion 33 extending away from the under surface 30 at an angle and terminating in a pair of closely spaced parallel inwardly angled flanges 34a, 34b. The spacing of the mounting arms 31, 32 and their respective flanges 34a, 34b is such that each pair of flanges 34a, 34b is a sliding fit between respective adjacent fins 27 of the heat sink 20 in a manner that will be described below. Each arm 31, 32 carries two spaced mounting screws 70 projecting through the associated arm 31, 32 and extending between the associated pair of flanges 34a, 34b so that tightening a screw 70 increases the separation of the flanges 34a, 34b for a purpose to be described below.

Referring next to FIG. 3, the third extrusion is a bracket 37 formed by a hollow tube 38 with a radially extending longitudinal rib 39 extending along an upper surface of the tube 38. The lower end of the tube 38 rests on plate 40 that projects to either side of the tube 38 and then extends downwardly and away from the tube 38 to form two mounting arms 41, 42. Each mounting arm terminates in a pair of spaced inwardly directed flanges 43, 44. The flanges are arranged and spaced so that they are a sliding fit between respective pairs of adjacent fins 27 of the heat sink 20 in a manner to be described below. Each arm 41, 42 carries a mounting screw 70 projecting through the associated arm 41, 42 and extending between the associated pair of flanges 43, 44 so that tightening a screw 70 increases the separation of the flanges 43, 44 for a purpose to be described below

The first LED light assembly of FIGS. 4 and 5 is for mounting two LED light sources 62 and is formed as follows. First, a heat sink extrusion 20 is cut to a desired length to permit it to dissipate the heat generated by the two LED light sources 62 (see FIG. 11). The heat generating capacity of such sources 62 and the dissipating capacity of the heat sink 20 are known and so the required length can be calculated. For example, where the width of the mounting surface 21 is 160 mm, the length may be 400 mm.

The LED light sources 62 are mounted direct onto the under side of the mounting surface 21. Next, the casing 45 is cut to a length to accommodate the electronic circuitry required to control the LED light sources 62. This length of casing 35 is mounted on the heat sink 20 by sliding the flanges 43 of each mounting arm 41, 42 between respective pairs of the fins 27. This is seen in FIG. 5. The screws 70 are then tightened to expand the flanges 43 of each pair to grip against the adjacent fins 27 and so lock the casing 35 to the heat sink 20. The arrangement is such that, when mounted in this way, the under surface of the casing 35 rests on the fins.

Next, a length of the bracket 37 is cut and slid onto and connected to the fins 27 in the same way as the casing 35 as described above, using the screws 70 to expand the flanges 34a, 34b. The control electronics are then inserted into the second casing 35 and connected to the LED light sources 62 and the bracket 37 is used to mount the assembly.

The heat from the LED light sources 62 is conveyed by the mounting surface 21 to the dividing surfaces 26 and the heat dissipating surface 24 and thence to the fins 27. This structure is capable of maintaining the LED light sources 62 at a low temperature even in the absence of any cooling airflow. This increases the life of the LED light sources 62.

As seen in broken line in FIG. 5, the length of the heat sink extrusion 20 may be increased as required to mount and dissipate heat from further LED light sources 52. Where further control circuitry is required for such LED light sources 62, further casings 35 may be mounted on the fins 27 as described above. Further brackets 37 may also be carried by the fins 27 as described above.

The second LED light assembly shown in FIGS. 9, 10 and 11 is formed from sections of the extrusions of FIGS. 1 and 2 and by sections of three further extrusions that will now be described with reference to FIGS. 6, 7 and 8.

Referring next to FIG. 6, the first further extrusion is an anchor 45 formed by a tube 46 provided with an axially extending opening 47. The tube 46 is supported on a plate 48 by a pair of spaced walls 49. The plate 48 projects to both sides of the tube 46 and then extends downwardly and outwardly of the tube 46 to form first and second mounting arms 50, 51. Each mounting arm 50, 51 terminates in a pair of closely spaced parallel inwardly angled flanges 52a, 52b. The spacing of the mounting arms 50, 51 and their respective flanges 52a, 52b is such that each pair of flanges 52a, 52b is a sliding fit between respective adjacent fins 27 of the heat sink 20 as described above in relation to the casing 35 and the bracket 37. Each arm 50, 51 carries two spaced mounting screws 70 projecting through the associated arm 50, 51 and extending between the associated pair of flanges 52a, 52b so that tightening a screw 70 increases the separation of the flanges 52a, 52b for a purpose to be described below.

Referring next to FIG. 7, the second further extrusion is a link member 53 formed by a tube 54 with an axial flange 54a carrying a channel member 55. The channel member 55 has parallel side walls 56a, 56b and the base of the channel member 55 is formed as a part circular portion 57 whose diameter is greater than the spacing of the side walls 56a, 56b. The diameter of the tube 54 and the width of the channel member 55 is such that the tube 54 can be slid into the part open tube 46 of the anchor 45 described above with reference to FIG. 6 with the flange 54a projecting through the opening 47.

Referring next to FIG. 8, the third further extrusion is a mounting 58 that is T-shaped in cross section with a limb 59 and a cross member 60. The limb 59 terminates at its free end in a head 61. The size of the head 61 and the width of the limb 59 are such that the head 61 can be slid into the part circular portion 57 of the link member 53 with the limb 59 being received in the channel member 55.

Referring next to FIGS. 9, 10 and 11, the second LED light assembly will now be described. Parts common to FIGS. 9, 10 and 11 and to FIGS. 1 to 5 are given the same reference numerals and will not be described in detail.

Referring to FIGS. 9, 10 and 11, the second LED light assembly is formed by a heat sink 20 caning two LED light sources 62 arranged as described above with reference to FIGS. 4 and 5 with the control electronics are mounted in a suitable length of the casing 35 mounted on the fins 27 by the mounting arms 31, 32 as described above with reference to FIGS. 1 to 5.

In addition, the fins 27 carry two spaced sections of the anchor 45 with the mounting arms 50, 51 of these anchor 45 slid onto the fins 27 on either side of the portion of the first casing 28 and connected to the fins 27 by tightening the screws 70 as described above.

Each anchor 45 carries a respective section of link member 53 with the tube 54 of the link member 53 being received in the open tube 46 of the associated anchor 45 and the flange 54a passing though the axial opening 47.

Finally, a length of the mounting 58 extends through the channel members 55 of both link members 53 with the limb 59 and the head 61 of the mounting 58 being received in the channel members 55 and the part circular portions 57 respectively. The mounting 58 is fixed to the link members 53 by screws 71 (see FIG. 11). The link members 53 act to space the mounting 58 above the upper surface of the second casing 35. The assembly is then completed by inserting control electronics into the casing 28 and by supporting the assembly using the mounting 58.

The second LED light assembly can be supported using the mounting 58 and the link members 53 have limited rotation relative to the associated anchors 27 to allow adjustment of the position of the LED light sources 62. The angular position of the LED light sources 62 is fixed by tightening a screw 72 passing through the tube 46 and engaging the tube 54 of the link 53.

In all the embodiments described above with reference to the drawings, all the major parts are made from extrusions. These are then cut to length to suit the application. If more heat dissipating surface is required, a suitable longer length is used, If a bigger power supply or bracket is required, a longer length can be cut.

The cost of the extrusion tooling may be about 1% of the cost of conventional die casting or sand casting so there can be savings on the development and tooling. There can also be cost savings on the actual parts as the extrusion process may be far cheaper then a casting process.

An extrusion can also be far more thermally efficient than cast aluminium so the assemblies described above with reference to the drawings may require less mass of aluminium than a conventional light.

Further, the design of the extrusion is also very significant as the relationship between mass and surface area affects the efficiency of the heat sink especially with respect to the maintenance of the thermal gradient in high ambient temperatures.

The assemblies described above with reference to the drawings may be so efficient as to use only 60% of the surface area recommended for, and less than 50% of the material used by, conventional lights.

It will be appreciated that the embodiments described above may be modified in a number of ways. Other extrusions may be formed a cut into sections that are mounted on the heat sink 20. For example, different brackets and mountings may be so mounted.

The cross-sectional shape of the heat sink 20 may not be as described above with reference to the drawings. Other cross-sections may be used provided that they give required heat dissipation.

1. An LED light assembly comprising a metal extrusion forming a heat sink with a hollow interior and including a mounting surface for supporting and conveying heat from an LED light source mounted on the surface, a heat dissipating surface for receiving and dissipating heat from the mounting surface and a support.

2. An assembly according to claim 1 wherein the mounting surface is formed as a continuous lengthwise extending wall of the heat sink, the wall including at least one aperture for receiving an LED light source.

3. An assembly according to claim 2 wherein the wall is flat.

4. An assembly according to claim 2 wherein the wall has first and second longitudinally extending spaced side edges, the heat dissipating surface extending longitudinally along the extrusion and between said first and second edges to define said hollow interior.

5. An assembly according to claim 4 wherein the heat dissipating surface carries at least one heat dissipating fin.

6. An assembly according to claim 5 wherein the at least one fin extends longitudinally along the heat dissipating surface and away from said surface.

7. An assembly according to claim 6 wherein the heat dissipating surface is part-circular in cross-section, the at least one fin extending radially away from said surface.

8. An assembly according to claim 7 wherein a plurality of fins are provided, the fins being equally spaced around the heat dissipating surface.

9. An assembly according to claim 1 wherein the extrusion includes at least one dividing wall in the hollow interior of the extrusion and extending between the mounting surface and the heat dissipating surface.

10. An assembly according to claim 9 wherein a plurality of said dividing walls are provided.

11. An assembly according to claim 1 and further including an accessory formed by a section of a further extrusion and carried by said heat sink.

12. An assembly according to claim 11 wherein said accessory and the heat sink inter-engage by relative sliding movement in the direction parallel to the lengths of the respective extrusions.

13. An assembly according to claim 11 wherein the accessory comprises a mounting by which the heat sink can be mounted to a surface, the mounting including an anchor formed by a length of a second extrusion, the anchor being carried by said support.

14. An assembly according to claim 8, and further including an accessory formed by a section of a further extrusion and carried by said heat sink, wherein the accessory comprises a mounting by which the heat sink can be mounted to a surface, the mounting including an anchor formed by a length of a second extrusion, the anchor being carried by said support, wherein the anchor includes a pair of arms, the fins forming the support and the arms being a sliding fit with the fins to mount the anchor on the extrusion.

15. An assembly according to claim 13 wherein the mounting includes a linking member formed by a third extrusion, the anchor including a first connector part, the linking member including a second connector part engaging with the first connector part.

16. An assembly according to claim 15 wherein the first and second connector parts engage by relative sliding movement in a direction parallel to the lengths of the extrusions.

17. An assembly according to claim 15 wherein the mounting includes a mounting strip formed by a fourth extrusion and including a fourth connector part, the linking member including a third connector part engaging with the fourth connector part.

18. An assembly according to claim 17 wherein the fourth extrusion is an elongate member of generally T-shaped cross-section, the limb of the T forming said fourth connector.

19. An assembly according to claim 11 wherein the accessory comprises a casing for LED control circuitry, the casing being formed by a fifth extrusion and being carried by said support.

20. An assembly according to claim 19 and further including an accessory formed by a section of a further extrusion and carried by said heat sink, wherein the accessory comprises a casing for LED control circuitry, the casing being formed by a fifth extrusion and being carried by said support, wherein the casing includes a pair of arms, the fins forming the support and the arms being a sliding fit with the fins to mount the casing on the extrusion.

21. An assembly according to claim 1 wherein the extrusion is formed from aluminium.

22. An assembly according to claim 1 and carrying at least one LED light source.

23. A method of forming an LED light assembly comprising forming a hollow metal heat sink extrusion including a mounting surface, a heat dissipating surface and a support, cutting a length of said extrusion to form a heat sink and mounting an LED light source on the mounting surface of said heat sink.

24. A method according to claim 24 and comprising forming a further metal extrusion, cutting a length of the further extrusion to form an accessory for the assembly and mounting the accessory on the heat sink.

25. A method according to claim 24 and comprising forming the heat dissipating surface with a plurality of fins, the fins being equally spaced around the heat dissipating surface, and forming the second extrusion with a pair of arms and then sliding the arms into engagement with the fins in a direction parallel to the lengths of the extrusions to mount the accessory on the heat dissipating surface with the fins forming said support.

26. A method according to claim 23 and comprising mounting an LED light source on the mounting surface, the length of the heat sink being chosen to provide required heat dissipation for the LED light source.
